(19) United States
(12) Patent Application Publication
(10) Pub. No.: US 2017/0111474 A1
(43) Pub. Date: Apr. 20, 2017

(54) DATA TRANSMISSION

(71) Applicant: METENSIS LIMITED, Oxfordshire (GB)

(72) Inventor: Lionel Scott, Oxfordshire (GB)

(73) Assignee: Metensis Limited, Oxfordshire (GB)

(21) Appl. No.: 15/317,557

(22) PCT Filed: Jun. 12, 2015
(86) PCT No.: PCT/GB2015/051739

§ 371 Date: Dec. 9, 2016

(30) Foreign Application Priority Data
Jun. 13, 2014 (GB) 1410550.6

(51) Int. Cl. H04L 29/08; H04L 12/801

(52) U.S. Cl. CPC H04L 67/327; H04L 47/34; H04L 67/02

(57) ABSTRACT

Methods for sending data between client devices, applications therefore, non-transitory computer media, and devices comprising non-transitory computer media.

The present invention relates to methods and applications for sending information and/or data between devices. In particular, the present invention relates to steps of identifying and splitting user information and/or data and sending it from at least one client device to at least a second client device through at least one communication channel.

One of the problems of electronic communication is that the confidentiality of transmitted information and/or data, (also referred to herein as ‘message content’) between users of devices is readily compromised. For the purposes of the present invention where information and/or data or message content is typed into a device it includes typed messages sent via email or text messages sent by mobile telephone and/or separate files that may be attached to such messages, such as, videos, images or photographic representations, documents and the like. Where the communication devices are mobile telephones or other devices e.g. computers using a Skype™ program, the message content may be provided in oral form to the device by a user and transmitted to a second or more devices by radio wave (e.g. by Wi Fi) or using a visible light band (e.g. Li Fi). Once the message content is received by the second or more devices, it is transcribed into a sound wave and/or live video or film. In certain electronic transactions, for example, those between users of social media, business to business, business to client transactions, and telephone conversations there is a need to retain privacy or confidentiality for as long as feasibly possible.

The rise of communication channels, such as social networks, has grown in the past decade or so to such an extent that there are now over five billion users of the internet employing over 200 mainstream communication channels worldwide. Information and/or data such as messages, diagrams, images and other attachments sent via the internet or other wireless communications are accessible by anyone with the right tools in transit between user devices; this information and/or data is not only able to be tracked but can be read and stored by others. As such, the use of wireless electronic communication pathways, including those of the internet, is open to abuses of confidentiality and the misappropriating of information.

For the purposes of the present invention the term ‘data’ is used as a mass noun in accordance with modern English usage and takes a singular verb, unless context demands otherwise, namely, when the word ‘data’ may or does refer to scientific use of the word, in which case the word ‘data’ is treated as a plural of ‘datum’ and takes a plural verb. The terms ‘information’ and ‘data’ and ‘message content’ are used interchangeably unless context demands otherwise.

Local Area Networks (LAN) such as Wi Fi, Light Fidelity (Li Fi) and Ethernet, as well as intranet channels, that is to say communication channels that are not of the internet may also be compromised if a third party is able to access such networks and acquire information. Such networks are also accessible to anyone with the right tools albeit that such access may in itself be illegal or may offend legal security provisions at the national and/or regional level, particularly if the targeted communication channels are of military and/or strategic significance.

In a similar vein, electronic oral communication between mobile phones, mobile phones and so-called landline telephones may also be compromised by electronic eavesdropping by third parties.

Solutions to the problem of retaining confidentiality of information sent via electronic nets such as LAN, intranet, and internet communication channels have seen the creation of complex computer programs which act to encrypt and decrypt data that is sent via such channels or pathways. An example of such a solution is the Pretty Good Privacy (PGP) program, which became available for the first time in 1991. The PGP program can be downloaded onto a computer of a first user and corresponding second user and used to encrypt messages prior to sending and then decrypting them at the receiver computer. PGP and similar software now follow the OpenPGP standard (RFC 4880) for encrypting and decrypting data and information of any kind. The PGP programs are efficient at what they do, but require regular updating as the PGP program and similar programs can be compromised by third parties who are able to crack the code(s). The PGP programs are constantly updated to take into account third party code-cracking activity. Users of PGP programs must have encryption keys to work the program successfully. Retaining such keys and keeping them secret can prove problematic.

There is a need for better control of confidentiality and privacy in methods of electronic communication between devices that are able to send and accept data electronically.

An object of the present invention is to provide a safer method of sending data via electronic communication channels that does not rely exclusively on using complex encryption methods.

A further object of the invention is to provide a simple means by which data may be sent over electronic networks without the use of encryption methods that disguise the identity of the user and receiver.

These and other objects shall become evident from the following description.

According to the present invention, there is provided a method of sending data between at least a first and at least a second client device, the method comprising:

at the first client device
i) identifying a block of user data to be sent to the second client device,
ii) splitting the block of user data into a plurality of ordered sub-blocks, and
iii) sending the sub-blocks to the second client device via at least one communication channel such that consecutive ones of the sub-blocks are not sent over the, or the same, communication channel, and
at the second client device
ia) receiving the sent sub-blocks via the communication channel, and
iib) ordering the sub-blocks into the correct order to re-assemble said block of user data. The at least first client device may be selected from any device that can be used to transmit data from it to a second device or a plurality of second devices. Typically, the data sent from the first device to the second device or devices is transmitted via a logical topology network such as a point-to-point topology that may be permanent (also known to the skilled addressee as ‘dedicated’) or switched, that is to say, by using circuit-switching or packet-switching technologies, wherein a point-to-point circuit is set up dynamically and dropped when no longer needed.

For the purposes of the present specification, the terms ‘device’ and ‘devices’ are used interchangeably unless context demands otherwise. The at least second client device may be selected from devices that are of the same kind of the first device or may be selected from devices that are different from the first device. Suitable first and second devices for use in the invention encompass computers, including personal computers (PCs), laptops, mainframe and super computers, Tablets, mobile phones including smart phones using operating systems such as Android, iOS (for iPhone and iPad), Windows Phone, Blackberry, Firefox OS, Sailfish OS, Tizen (a Linux-based operating system), Ubunt Touch, Li Fi systems in which data is carried to and from a microchip via visible light wavelengths generated from a light source, typically, a light emitting diode (LED) light source, and robotic devices, for example, program software located in robotic vehicles and/or in specialised vehicles. Specialised vehicles includes manned planes, ordnance including missiles, torpedoes, artillery shells, and solid state military lasers, military hardware such as tanks, naval surface ships and submarines, manned and autonomous vehicles, robots such as Big Dog produced by Boston Dynamics, aerial reconnaissance vehicles (ARVs), unmanned aerial vehicles (UAVs), unmanned combat vehicles (UCAVs) and the like.

The sending of data may occur between a single first device and a single second device; between a single first device and a plurality of second devices; between a plurality of first devices and a plurality of second devices; or between a plurality of first devices to a single second device, depending on the end purpose of the transmitted data. In a social media context, the sending of data such as text or images (pictures) is typically sent from one device, e.g. a laptop or mobile phone to at least one or more receiver devices that the user of the first device selects. A first user may simply send data from a mobile phone or laptop to a sole second client user via a communication channel such as a social network site e.g. Facebook™ or Google™

A block of user data at the at least first client device is data that may take the form of a text message or email and/or an attachment thereto, such as an image or document that the user of the first client device determines to send to a second client device. The data may be in any form such as text e.g. email or text message or in the form of a command; a set of instructions containing pictorial representations and text; attached pictures (images) per se; attached documents; or other attachments. The block of user data at the first client device is split into a plurality of first ordered sub-blocks by an application (an ‘app’) located on the first client device that are then sent to at least a second client device via at least one communication channel such that the plurality of first ordered sub-blocks are not sent consecutively over the same communication channel. Thus, where a method of the invention uses only one communication channel between a first and second client device, the plurality of first ordered sub-blocks of data can be sent out in a plurality of second ordered sub-blocks of data that is different in order from the plurality of first ordered sub-blocks. The re-ordered plurality of second ordered sub-blocks of data in this aspect of the invention is sent to a second client device via a single communication channel as a plurality of independent data packages and is received thereat where the re-ordering of the second ordered sub-blocks into the plurality of first ordered sub-blocks is effected, and if necessary, is then followed by ordering the first ordered sub-blocks in the second client device into the correct order for re-assembly of the user data into a comprehensible, readable form using a like ‘app’ in the receiving second device or devices. The ‘app’ that is used in such communications may be a web-based ‘app’, that is to say, is located in the Web browser of each of the sending and receiving devices or it may be a native ‘app’ that is loaded into the first and second devices and communicates with the internet, intranet, WLAN, LAN or private communication channels using its own Application Programming Interface software. Preferably, the ‘app’ is a native ‘app’ that uses its own Application Program Interface software to communicate with selected communication channels, and thereby enable the transmission of data. Application Programming Interface software are referred to herein as ‘API’ or ‘APIs’.

The block of first user data may be split into a plurality of first ordered sub-blocks of any size from a range of sizes that the first client device user selects. The size of the first ordered sub-blocks of data in the first client device can be of any size or sizes that may be pre-programmed into the ‘app’ of the invention and therefore are of a ‘predetermined size’ that may be selected from a plurality of different sized sub-blocks. The ‘app’ of the invention may be used in devices that operate through Wi Fi systems, that is to say systems that are dependent on using radio wave banding. In an alternative, the ‘app’ of the invention may be employed in devices using Light Fidelity (Li Fi) systems developed through the work of Prof. Harald Haas, which systems use light banding from the visible spectrum of light. Li Fi-based systems are preferred because the available bandwidth of visible light is about 10,000× that of radio waves upon which Wi Fi systems depend. Both Wi Fi and Li Fi systems use similar IEEE 802.11 protocols.

If the first user data is in the form of text, for example in the form of an email or a text message, then the plurality of first ordered sub-blocks may be of any size such as sub-letter sized, or of individual letters or of pre-determined blocks of letters, which may then be re-ordered into a plurality of second ordered sub-blocks of data using appropriate software, such as Javascript, and sent to a second client device. Each second ordered sub-block of data may correspond to a subset of each first ordered sub-block of data such that at least two second ordered sub-blocks of data may correspond to each first ordered sub-block of data. The size of the first ordered sub-blocks of data and the size of the second ordered sub-blocks of data sent to a second client device may be predetermined by software that performs the identifying and splitting of block user data. The second ordered sub-blocks of data are then sent to a second client device. Thus the size of the second ordered sub-blocks of data that are sent to a second client device from a first client device can be of any size or sizes that may be pre-programmed into the ‘app’ of the invention and therefore are of a ‘predetermined size’ or are selected from a plurality of pre-determined sizes. The ‘app’ of the invention may be used in devices that operate through Wi Fi systems, that is to say systems that are dependent on using radio wave banding. In an alternative, the ‘app’ of the invention may be employed in devices using Light Fidelity (Li Fi) systems as described hereinabove.

Any communication channel, such as a social network, may be used to send data according to the above aspect of the invention. Communication channels that may be employed in a method of this aspect of the invention may be selected from any of the social networks, herein referred to by way of their respective trademarks: Facebook, Alibaba, Tencent QQ, Google+, Whatsapp, WeCHat, Skype, Twitter, LinkedIn, Instagram, Tencent Qzone, LINE, Momo, Mi Talk, Yixin, Odnoklassniki, Reddit, Viber, Sina Weibo, Tumblr, Windows Live, Dropbox, Nimbuzz, VKontakte, Orkut, Qzone, Renren, Tagged, Tango and Yahoo; and smaller social networking sites such as 43 things, Academia.edu, About.me, Advogato, allobii, AsianAvenue, aSmallworld, Athlinks, Bebo, Black Planet, Busuu, Buzznet, Care2, CaringBridge, Classmates.com, Cyworld, deviantART, Draugiem.Iv, douban, DXY.cn, English,baby!, eToro, Flixster, Flickr, Focus.com, Formspring, Fotoblog, Foursquare, Friends Reunited, Friendster, Gaia Online, Geni.com, GetGlue, Goodreads, Grono.net, Habbo, hi5, Hyves, Ibibo, Itsmy, iWiW, Jiepang, Kiwibox, Last.fm, LibraryThing, LiveJournal, Livemocha, mixi, MocoSpace, Myheritage, MyLife, My Opera, Myspace, Nasza-klasa.pl, Netlog, Nexopia, Open Dairy, Plaxo, Skyrock, Sonico.com, SoundCloud, Stickam, StudiVZ, StumbleUpon, Taringa!, Tuenti, Viadeo, WAYN, WeeWorld, We Heart It, weRead, Xanga, XING, Zoo.gr and the like.

Further communication channels other than social networks may be used to send data according to the method of the present invention that are not accessible by the internet such as other Wi Fi networks, for example private networks, Li Fi networks both private and internet based, including LAN, WLAN, and intranet channels, and the like.

The steps of identifying and splitting the data into first ordered sub-blocks, and then converting the first ordered sub-blocks into second ordered sub-blocks according to this first aspect of the invention are performed by an application running on the first client device, the application communicating with the client of the communication channel via an Application Programming Interface, API, in order to cause the client to perform the step of sending the second ordered sub-blocks to the second client device. The step of receiving the sent second ordered sub-blocks is performed by the client of the communication channel on the second client device, and the step of re-ordering the second ordered sub-blocks into the correct order of the first ordered sub-blocks is performed by an application communicating with the respective clients of the communication channel via an Application Interface, API, in order to receive the received sub-blocks. Optionally, the received first ordered sub-blocks of data in the second client device may require re-ordering into the correct order. Whether received in order or otherwise, received ordered sub-blocks are followed by re-assembly of the first ordered block of user data into a comprehensible and readable form using an adaptation of the application.

Thus, in devices of the invention that carry ‘Apps’ of the invention they are able to split up a single block of data within the device and release it as a plurality of independent messages that leave the device as individual messages that are directed through preferably more than one communication channel to a receiving device. The data sent from one device to another is sent in a structured format that is recognised by the receiving device. The individual messages that are sent out may be stored on servers but are not stored in a comprehensible format on any one server because they have no readily comprehensible form. It is only when the data is accepted by a receiver device carrying the same software as the sender device that sent data is ordered into a comprehensible form. By using software of the invention the only locations where the data is created and stored in comprehensible form is on the sending and receiving devices. Thus, by manipulating the size of the messages that leave devices of the invention, message content stored on servers can remain private because it cannot be readily comprehended, if at all. Devices of the invention do not need to rely on disguising the source of the sender(s) and receiver(s) as is used in other privacy systems, for example, by Tor and the Dark Net. There is no absolute need to use encryption keys to access information sent via devices using the software and methods of the invention. Furthermore, where users require a higher level of privacy other than that provided by the present invention, encryption software may be employed to further disguise the message content of the sub-blocks of information that are sent out by devices of the invention. In such cases, it is again not necessary to disguise the source of the sender(s) or receiver(s). Data or message content in the form of separate sub-blocks may be disguised using simple encryption software which may also be carried by the ‘App’ located in both sending and receiving devices. Such encryption software may be web-based software located in, for example, a web browser, or it may be native software that is located on the device and is not readily accessible by a third party. Preferably, the encryption software is native software, that is to say, is carried by devices of the invention and is not web-based.

Both the software of the invention, the ‘App’ and any encryption software that may operate in conjunction with it are preferably located on the device and may be further protected with firewalls against computer virus or other malicious software.

As a further aspect of the invention, there is provided an application for use in a method of the invention, which application is capable of running on a first client device, the application communicating with the client of the communication channel via an Application Programming Interface, API, in order to cause that client to perform the said step of sending the sub-blocks to the second client device.

As a further aspect of the invention, there is provided an application for use in a method of the invention, which application is capable of running on the second client device, which application is capable of ordering the sub-blocks into the correct order, the application communicating with the client of the communication channel via an Application Programming Interface, API, in order to receive the received sub-blocks.

Typically, both applications for use in the invention and corresponding APIs may be found on the first and second client devices and may be the same or different depending on purpose. In both devices, the applications should be capable of translating received information into a comprehensible format.

According to this aspect of the invention there is preferably provided a method of sending data between first and second client devices, the method comprising:

at the first client device
identifying a block of user data to be sent to the second client device,
splitting the block of user data into a plurality of ordered sub-blocks, and
sending the sub-blocks to the second client device via two or more communication channels such that consecutive ones of the sub-blocks are not sent over the same communication channel, and
at the second client device
receiving the sent sub-blocks via the two or more communication channels, and
ordering the sub-blocks into the correct order to re-assemble said block of user data.

The at least first client device may be selected from any device that can be used to transmit data from it to a second device or second devices. For the purposes of the present specification, the terms ‘device’ and ‘devices’ are used interchangeably unless context demands otherwise. Both the first and second device may be suitable first and second devices for use in this aspect of the invention encompass computers, including personal computers (PCs), laptops, mainframe and super computers, Tablets, mobile phones including smart phones using operating systems such as Android, iOS (for iPhone and iPad), Windows Phone, Blackberry, Firefox OS, Sailfish OS, Tizen (a Linux-based operating system), Ubunt Touch, and Li Fi systems in which data is carried to and from a microchip via visible light wavelengths generated from a light source, typically, a LED light source, and robotic devices, for example, program software located in robotic vehicles and/or in specialised vehicles. Specialised vehicles includes manned planes, ordnance including missiles, torpedoes, artillery shells, and solid state military lasers, military hardware such as tanks, naval surface ships and submarines, manned and autonomous vehicles, robots such as Big Dog produced by Boston Dynamics, aerial reconnaissance vehicles (ARVs), unmanned aerial vehicles (UAVs), unmanned combat vehicles (UCAVs) and the like. In this aspect of the invention, the at least second client device may be selected from devices that are of the same kind of the first device or may be selected from devices that are different from the first device.

In this aspect of the invention, the block of user data at the first client device is split into a plurality of first ordered sub-blocks that are sent to at least a second client device via at least two communication channels such that the plurality of first ordered sub-blocks are not sent consecutively over the same communication channel. Preferably, the first ordered sub-blocks of data are sent via a plurality of communication channels such that the data sent via each communication channel is made up of small packages that appear incoherent, that is to say, are not readily decipherable as a coherent part of a complete message. In this manner, data can be sent from a first client device to at least a second client device without first undergoing an encryption event in order to maintain privacy and/or secrecy of the sent data. The first ordered sub-blocks sent via any one communication channel may be of any size selected by the first client device and conveyed or conveyable to a second client device which is able to read the data and put it all together as comprehensible data. Thus, a single sub-block of information may be very small, for example, as little as a single letter of an alphabet or a single number and may be smaller still, if the program language contains code that codes for parts of data, e.g. parts of letters and/or numbers, that is to say elements of letters or numbers that are smaller than that of a single letter or number. If two or more channels of communication are used to send different parts of data to target second client device(s), the ability to track data and read it becomes even more problematic, if not impossible. Under such circumstances, the sent data are effectively indecipherable while in transit or as stored in the “cloud” or elsewhere. Data that reach their final destination may require further ordering before becoming comprehensible and this may be accomplished by adapting an application to accommodate such a task. Indeed, as a preferment of this aspect of the invention, data that are received in second client devices may be discarded by the second client device after having been read or having performed a task or tasks. Such data that may be discarded or are discarded can be split back into the same or different sub-blocks of information and sent back into the cloud or sent to trash where they remain stored in essentially an unintelligible form. Where a method of this aspect of the invention uses more than one communication channel between a first and second client device, the plurality of first ordered sub-blocks of data can be sent out to a second client device via preferably several communication channels, from 2 upwards in number, such as 3, 4, 5, 6, 7, 8, 9, or 10, for example, 20, 30, 40, 50, 60, or up to 200 or any number thereinbetween or even a higher number. Generally, the level of secrecy or privacy of information exchanged between users is higher the more channels of communication are used in the method of this aspect of the invention, depending on the level of privacy or secrecy that is sought by the users of the first and second client devices.

The application that is able to effect the splitting of data in a first sending device and the joining up of the data in the second device may optionally be capable of ordering of the first ordered sub-blocks in the second client device into the correct order for re-assembly of the user data into a comprehensible, readable form. In a further preferment, the same application may also be designed to take the data in comprehensible, readable form and after it has been read or has activated a particular task, turn the data back into the initial split sub-block form and either send it to trash or into the cloud. Either way, the re-split data that is sent to trash or into the cloud appears unintelligible to others. By safeguarding data in this way, reliance on the use of complex encryption programs to keep data secret is substantially reduced.

The communication channels that may be used in this aspect of the invention may be selected from any communication channel such as those of social media networks, including but not limited to, and referred to by way of their respective trademarks: Facebook, Tencent QQ, Google+, Whatsapp, WeCHat, Skype, Twitter, LinkedIn, Instagram, Tencent Qzone, LINE, Odnoklassniki, Reddit, Viber, Sina Weibo, Tumblr, Windows Live, Dropbox, Nimbuzz, VKontakte, Orkut, Qzone, Renren, Tagged, and Yahoo; and smaller social networking sites such as 43 things, Academia.edu, About.me, Advogato, allobii, AsianAvenue, aSmallworld, Athlinks, Bebo, Black Planet, Busuu, Buzznet, Care2, CaringBridge, Classmates.com, Cyworld, deviantART, Draugiem.Iv, douban, DXY.cn, English,baby!, eToro, Flixster, Flickr, Focus.com, Formspring, Fotoblog, Foursquare, Friends Reunited, Friendster, Gaia Online, Geni.com, GetGlue, Goodreads, Grono.net, Habbo, hi5, Hyves, Ibibo, Itsmy, iWiW, Jiepang, Kiwibox, Last.fm, LibraryThing, LiveJournal, Livemocha, mixi, MocoSpace, Myheritage, MyLife, My Opera, Myspace, Nasza-klasa.pl, Netlog, Nexopia, Open Dairy, Plaxo, Skyrock, Sonico.com, SoundCloud, Stickam, StudiVZ, StumbleUpon, Taringa!, Tuenti, Viadeo, WAYN, WeeWorld, We Heart It, weRead, Xanga, XING, Zoo.gr and the like.

Further communication channels other than social networks may be used to send data according to the method of this aspect of the present invention that are not accessible by the internet such as other Wi Fi networks, for example private networks, Li Fi networks both private and internet based, including LAN, WLAN, and intranet channels, and the like.

The skilled addressee will also appreciate that a combination of LAN, private networks and social media networks may be used to transfer data from a first client device to a second client device under this aspect of the present invention.

The steps of identifying and splitting the data into first ordered sub-blocks, and then sending the data to a second client device through the two or more channels of communication in this aspect of the invention are performed by an application running on the first client device, the application communicating with the respective clients of the communication channels via Application Programming interfaces (APIs), in order to cause those clients to perform the step of sending the sub-blocks to the second client device. The step of receiving the sent ordered sub-blocks is performed by clients of the communication channels on the second client device and is performed by an application communicating with the respective clients of the communication channels via Application Interfaces (APIs), in order to receive the received sub-blocks. Optionally, the received first ordered sub-blocks of data in the second client device may be re-ordered into the correct order, if required, into a comprehensible and readable form using an adaptation of the application. A further adaptation to the application of use in this aspect of the invention is to adapt the application to split reconstituted data back into the split form and send it to the cloud or to trash in split form after it has been read or after a finite time interval or after the data has been used to elicit a specific task, for example a directional task. In this way, data may be held in essentially incomprehensible if not totally incomprehensible form, that may potentially be retrievable should retrieval be desired. In other adapted applications, data may be used only once and once used is not possible to retrieve.

In a variant of this aspect of the invention, the block of first user data may be split into a plurality of first ordered sub-blocks of any size that the first client device user selects. If the first user data is, for example, in the form of an email or a text message, then each of the plurality of first ordered sub-blocks may be up to the size of individual letters or larger, which may then be converted into an appropriate software language, such as Javascript, and sent to a second client device.

In a further aspect of the invention there is a provided an application that is capable of running on a first client device, which application is capable of identifying and splitting a block of user data into a plurality of ordered sub-blocks, which application communicates with the respective clients of communication channels via Application Programming Interfaces (APIs) by causing the clients to perform the step of sending the sub-blocks of data to the second client device.

In another aspect of the invention there is provided an application that is capable of running on a second client device wherein the step of receiving sub-blocks of data from a first client device(s) is performed by clients of the communication channels on the second client device, which application runs on the second client device and is capable of ordering the sub-blocks into the correct order, the application communicating with the respective clients of the social networks via Application Programming Interfaces (APIs), in order to receive the received sub-blocks.

As a further aspect of the invention there is provided a method of sending data from a first to a second client device, the method comprising:

at the first client device
i) identifying a block of user data to be sent to the second client device,
ii) splitting the block of user data into a plurality of ordered sub-blocks, and
iii) sending the sub-blocks to the second client device via at least one communication channel such that consecutive ones of the sub-blocks are not sent over the, or the same, communication channel.

In a preferment of this aspect of the invention step iii) comprises sending the sub-blocks via two or more different communication channels selected from communication channels as defined hereinabove. Preferably, at least one of the channels comprises a social network.

In a further aspect of the invention, there is provided a non-transitory computer medium storing a software program, such as a computer program, arranged to send data from a first to a second client device, the software program comprising code for:

at the first client device
i) identifying a block of user data to be sent to the second client device,
ii) splitting the block of user data into a plurality of ordered sub-blocks, and
iii) sending the sub-blocks to the second client device via at least one communication channel such that consecutive ones of the sub-blocks are not sent over the, or the same, communication channel.

In a further aspect of the invention there is provided a device comprising a non-transitory computer medium storing a software program, such as a computer program, arranged to send data from a first to a second client device, the software program comprising code for:

at the first client device
i) identifying a block of user data to be sent to the second client device,
ii) splitting the block of user data into a plurality of ordered sub-blocks, and
iii) sending the sub-blocks to the second client device via at least one communication channel such that consecutive ones of the sub-blocks are not sent over the, or the same, communication channel.

There now follow descriptions illustrating the invention. It is to be understood that the illustrations are not to be construed as limiting the scope of the invention in any way.

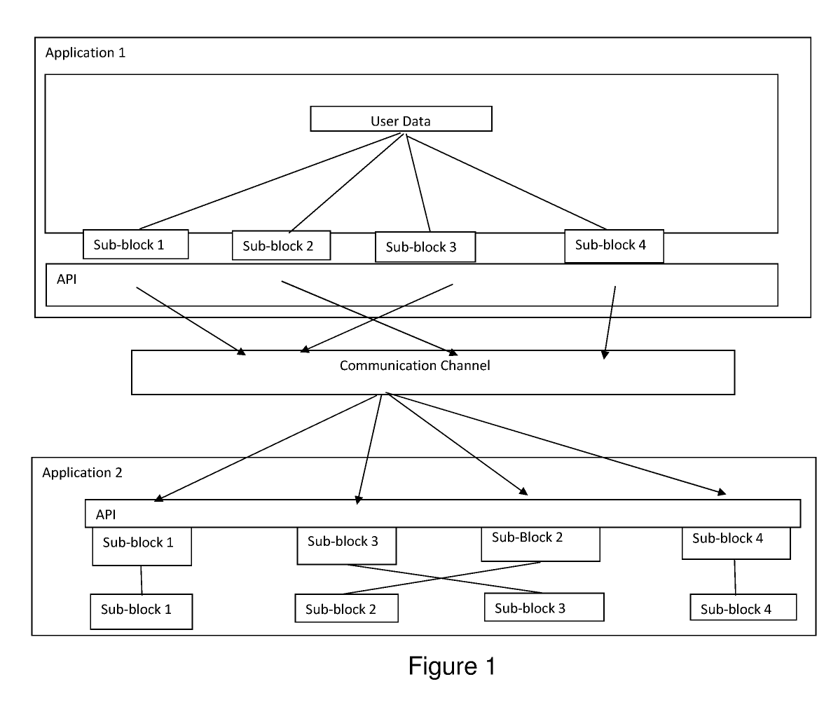

FIG. 1 is a flow diagram of the method of the invention as performed over one communication channel.

User data for sending to a second client device is identified in a first client device and split into a plurality of ordered sub-blocks (sub-blocks 1, 2, 3 and 4) via Application 1 which sends the sub-blocks to a single communication channel via an API. The data is sent via the single communication channel, e.g. Google™, to a second client device which houses an Application 2 that recognises and accepts the data sub-blocks in any order, in this case, in the order of sub-blocks 1, 3, 2, and 4, and re-orders them into consecutive sub-block order. The second client device then assembles the consecutive sub-blocks into user data in readable form (not shown).

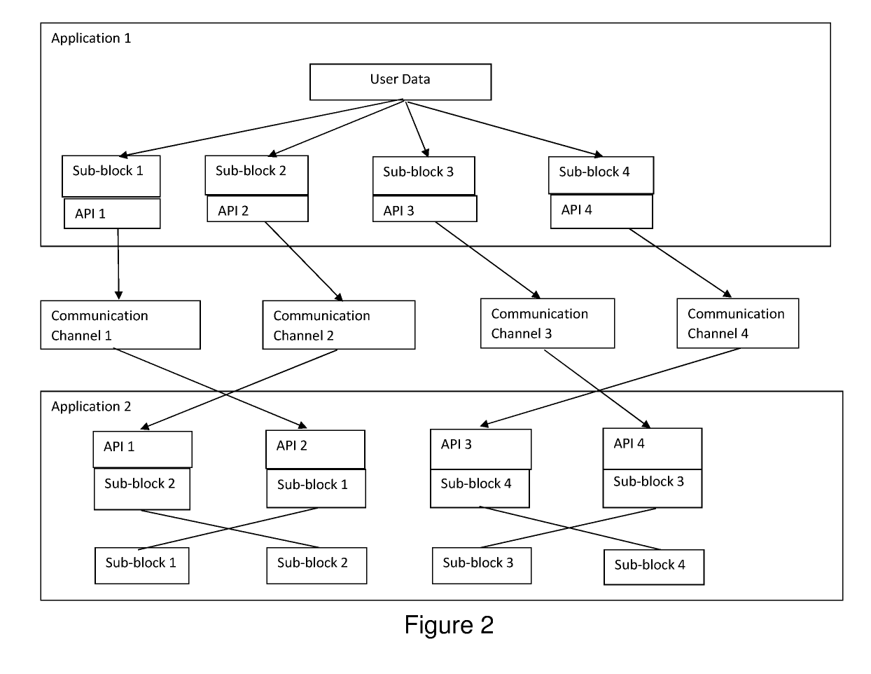

FIG. 2 is a flow diagram of the method of the invention as performed over a plurality of communication channels.

User data for sending to a second client device is identified in a first client device and split into a plurality of ordered sub-blocks (sub-blocks 1, 2, 3 and 4) via Application 1 which sends the sub-blocks to a plurality of different communication channels, shown as communication channels 1, 2, 3, and 4, via different APIs shown as API 1, API 2, API 3, and API 4. The data is sent via the communication channels to a second client device which houses an Application 2 that recognises and accepts the data sub-blocks in any order, in this case, in the order of sub-blocks 2, 1, 4, and 3, and re-orders them into consecutive sub-block order. The second client device then assembles the consecutive sub-blocks into user data in readable form (not shown).

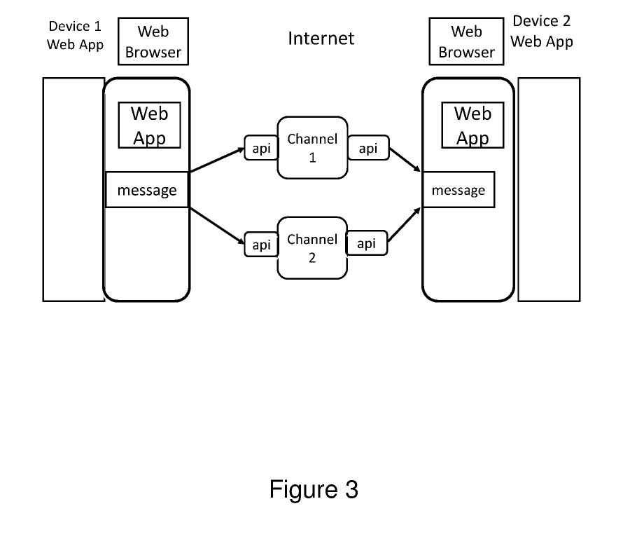

FIG. 3 is a flow diagram of the method of the invention as performed over a plurality of communication channels using a Web-based App.

User data shown as ‘message’ for sending to a second client device is identified in a first client device (Device 1) and split into a plurality of ordered sub-blocks (not shown) via the ‘Web App’ which sends the sub-blocks through different communication channels, shown as channels 1 and 2, via different APIs shown as ‘api’ to the left and right of Channels 1 and 2, respectively. The data is sent via channels 1 and 2, in this case communication channels of Facebook and Google, to a second client device which houses a Web-based App in its browser that recognises and accepts the data sub-blocks in any order (not shown), and re-orders them into consecutive sub-block order. The second client device then assembles the consecutive sub-blocks into user data in readable form (not shown).

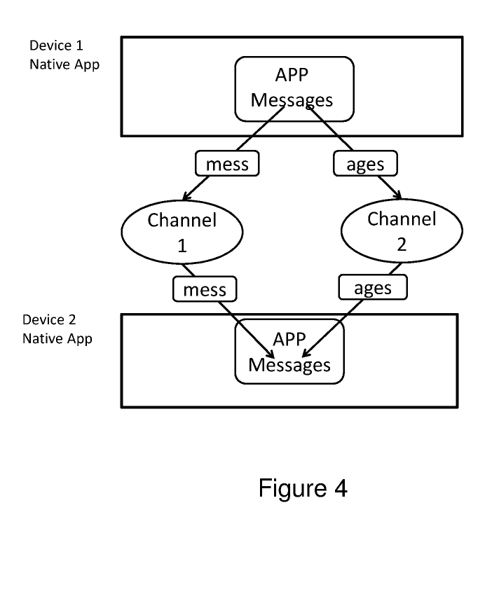

FIG. 4 is a flow diagram of the method of the invention as performed over a plurality of communication channels using native Apps and APIs that are located in Devices 1 and 2.

User data shown as ‘message’ for sending to a second client device is identified in a first client device (Device 1) and split into a plurality of ordered sub-blocks (mess' and ‘ages’) via the ‘APP’ which sends the sub-blocks through different communication channels, shown as channels 1 and 2, via APIs (not shown) located in Devices 1 and 2. The data (i.e. ‘message’) is sent via channels 1 and 2, in split form, to a second client device (Device 2) which houses a native App that recognises and accepts the data sub-blocks in any order (not shown), and re-orders them into consecutive sub-block order. The second client device then assembles the consecutive sub-blocks into user data in readable form (Messages′).

1-19. (canceled)

20. A method of sending data between at least a first and at least a second client device, the method comprising:
at the first client device
i) identifying a block of user data to be sent to the second client device,
ii) splitting the block of user data into a plurality of ordered sub-blocks, and
iii) sending the sub-blocks to the second client device via
a single communication channel including re-ordering the sub-blocks for transmission, or
at least two communication channels including sending successive sub-blocks over different communication channels,
at the second client device
ia) receiving the sub-blocks via the communication channel(s), and
iib) ordering the sub-blocks into the correct order to re-assemble said block of user data.

21. A method according to claim 20, wherein the communication channel(s) is(are) provided by a social network or a private network.

22. A method according to claim 20, wherein the communication channel(s) is(are) provided by a LAN or an intranet channel.

23. A method according to claim 20, wherein the steps of identifying and splitting are performed by an application running on a first client device, the application communicating with a client or clients of the communication channel(s) via one or more Application Programming Interfaces (APIs) in order to cause that client to perform the step of sending the sub-blocks to the second client device.

24. A method according to claim 23, wherein the application and application programming interfaces are selected from a native application and one or more APIs.

25. A method according to claim 21, wherein the steps of identifying and splitting are performed by an application running on a first client device, the application communicating with a client or clients of the communication channel(s) via one or more Application Programming Interfaces (APIs) in order to cause that client to perform the step of sending the sub-blocks to the second client device.

26. A method according to claim 22, wherein the steps of identifying and splitting are performed by an application running on a first client device, the application communicating with a client or clients of the communication channel(s) via one or more Application Programming Interfaces (APIs) in order to cause that client to perform the step of sending the sub-blocks to the second client device.

27. A method according to claim 21, wherein the step of receiving the sent sub-blocks is performed by the client(s) of the communication channel(s) on the second client device, and the step of ordering the sub-blocks into the correct order is performed by an application running on the second client device, the application communicating with the client(s) of the communication channel(s) via one or more Application Programming Interfaces (APIs) in order to receive the received sub-blocks.

28. A method according to claim 22, wherein the step of receiving the sent sub-blocks is performed by the client(s) of the communication channel(s) on the second client device, and the step of ordering the sub-blocks into the correct order is performed by an application running on the second client device, the application communicating with the client(s) of the communication channel(s) via one or more Application Programming Interfaces (APIs) in order to receive the received sub-blocks.

29. An application for use in a method according to claim 20, the application being capable of running on a first client device, the application communicating with the client(s) of the communication channel(s) via one or more Application Programming Interfaces (APIs) in order to cause the client(s) to perform the step of sending the sub-blocks to the second client device.

30. An application for use in a method according to claim 21, the application being capable of running on a first client device, the application communicating with the client(s) of the communication channel(s) via one or more Application Programming Interfaces (APIs) in order to cause the client(s) to perform the step of sending the sub-blocks to the second client device.

31. An application for use in a method according to claim 22, the application being capable of running on a first client device, the application communicating with the client(s) of the communication channel(s) via one or more Application Programming Interfaces (APIs) in order to cause the client(s) to perform the step of sending the sub-blocks to the second client device.

32. An application for use in a method according to claim 20, the application being capable of running on the second client device, the application being capable of ordering the sub-blocks into the correct order, the application communicating with the client(s) of the communication channel(s) via one or more Application Programming Interfaces (APIs) in order to receive the received sub-blocks.

33. An application for use in a method according to claim 21, the application being capable of running on the second client device, the application being capable of ordering the sub-blocks into the correct order, the application communicating with the client(s) of the communication channel(s) via one or more Application Programming Interfaces (APIs) in order to receive the received sub-blocks.

34. An application for use in a method according to claim 22, the application being capable of running on the second client device, the application being capable of ordering the sub-blocks into the correct order, the application communicating with the client(s) of the communication channel(s) via one or more Application Programming Interfaces (APIs) in order to receive the received sub-blocks.

35. A method of sending data between at least a first and at least a second client device, the method comprising:
at the first client device
identifying a block of user data to be sent to the second client device,
splitting the block of user data into a plurality of ordered sub-blocks, and
sending the sub-blocks to the second client device via two or more communication channels such that consecutive ones of the sub-blocks are not sent over the same communication channel, and
at the second client device
receiving the sent sub-blocks via the two or more communication channels, and
ordering the sub-blocks into the correct order to re-assemble said block of user data.

36. A method according to claim 35, wherein the two or more communication channels are provided by respective social networks, or respective private networks or a selection thereof.

37. A method according to claim 35, wherein the steps of identifying and splitting are performed by an application running on a first client device, the application communicating with respective clients of the two or more communication channels via Application Programming Interfaces (APIs) in order to cause those clients to perform said step of sending the sub-blocks to the second client device.

38. A method according to claim 37, wherein the application and application programming interfaces are selected from a native application and one or more APIs.

39. A method according to claim 35, wherein the step of receiving the sent sub-blocks is performed by clients of the two or more communication channels on the second client device, and said step of ordering the sub-blocks into the correct order is performed by an application running on the second client device, the application communicating with respective clients of the two or more communication channels via Application Programming Interfaces (APIs) in order to receive the received sub-blocks.

40. A method according to claim 37, wherein the application and application programming interfaces are selected from a native application and one or more APIs.

41. A method according to claim 36, wherein the step of receiving the sent sub-blocks is performed by clients of the two or more communication channels on the second client device, and said step of ordering the sub-blocks into the correct order is performed by an application running on the second client device, the application communicating with respective clients of the two or more communication channels via Application Programming Interfaces (APIs) in order to receive the received sub-blocks.

42. A method according to claim 20, wherein the step of splitting the block of user data into a plurality of ordered sub-blocks is carried at an application layer.

43. A method according to claim 20, wherein the communication channel or each of the at least two communication channels is an HTTP connection.

44. An application for use in a method according to claim 35, the application being capable of running on a first client device, the application communicating with respective clients of the communication channels via Application Programming Interfaces (APIs) in order to cause those clients to perform the step of sending the sub-blocks to the second client device.

45. An application for use in a method according to claim 44, wherein the application and application programming interfaces are selected from a native application and one or more APIs.

46. An application for use in a method according to claim 36, the application being capable of running on a first client device, the application communicating with respective clients of the communication channels via Application Programming Interfaces (APIs) in order to cause those clients to perform the step of sending the sub-blocks to the second client device.

47. An application for use in a method according to claim 46, wherein the application and application programming interfaces are selected from a native application and one or more APIs.

48. An application for use in a method according to claim 37, the application being capable of running on a first client device, the application communicating with respective clients of the communication channels via Application Programming Interfaces (APIs) in order to cause those clients to perform the step of sending the sub-blocks to the second client device.

49. An application for use in a method according to claim 48, wherein the application and application programming interfaces are selected from a native application and one or more APIs.

50. An application for use in a method according to claim 35, the application being capable of running on the second client device, the application being capable of ordering the sub-blocks into the correct order, the application communicating with respective clients of the communication channels via Application Programming Interfaces (APIs) in order to receive the received sub-blocks.

51. An application for use in a method according to claim 36, the application being capable of running on the second client device, the application being capable of ordering the sub-blocks into the correct order, the application communicating with respective clients of the communication channels via Application Programming Interfaces (APIs) in order to receive the received sub-blocks.

52. An application for use in a method according to claim 37, the application being capable of running on the second client device, the application being capable of ordering the sub-blocks into the correct order, the application communicating with respective clients of the communication channels via Application Programming Interfaces (APIs) in order to receive the received sub-blocks.

53. An application for use in a method according to claim 38, the application being capable of running on the second client device, the application being capable of ordering the sub-blocks into the correct order, the application communicating with respective clients of the communication channels via Application Programming Interfaces (APIs) in order to receive the received sub-blocks.

54. An application for use in a method according to claim 39, the application being capable of running on the second client device, the application being capable of ordering the sub-blocks into the correct order, the application communicating with respective clients of the communication channels via Application Programming Interfaces (APIs) in order to receive the received sub-blocks.

55. A method of sending data from a first to a second client device, the method comprising:
at the first client device
i) identifying a block of user data to be sent to the second client device,
ii) splitting the block of user data into a plurality of ordered sub-blocks, and
iii) sending the sub-blocks to the second client device via at least one communication channel such that consecutive ones of the sub-blocks are not sent over the, or the same, communication channel.

56. A method according to claim 55, wherein step iii) comprises sending the sub-blocks via two or more different communication channels, at least one of the channels comprising a social network.

57. A non-transitory computer medium storing a computer program arranged to send data from a first to a second client device, the computer program comprising code for:
at the first client device
i) identifying a block of user data to be sent to the second client device,
ii) splitting the block of user data into a plurality of ordered sub-blocks, and
iii) sending the sub-blocks to the second client device via at least one communication channel such that consecutive ones of the sub-blocks are not sent over the, or the same, communication channel.

58. A computer device comprising a non-transitory computer medium according to claim 57.
